(19) United States
(12) Patent Application Publication
(10) Pub. No.: US 2003/0204744 A1
(43) Pub. Date: Oct. 30, 2003

(54) Network access control

(76) Inventors: Robert-Claude Maltais, Repentigny (CA); Gerald Host, Montreal (CA); Nicolas Fournier, Lasalle (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 10/132,319

(22) Filed: Apr. 26, 2002

(51) Int. Cl. G06F 11/30; G06F 15/173

(52) U.S. Cl. 713/201; 709/223

(57) ABSTRACT

A method and a system for providing a terminal in a first network, in which the terminal has a network address, with access to a second network. A traffic node (TN) establishes a virtual network with the terminal and intercepts traffic sent by the terminal. If the terminal is not authorised to send traffic towards the second network, the TN notifies a network service node (LSN) that in turn sends a forced portal to the terminal. The user logs on, using the forced portal, the LSN verifies the log-on and, if successful, informs the TN that the terminal is authorised. The TN then updates a filter and lets the traffic through. If the second network belongs to an Internet Service Provider (ISP), then the TN logs the user onto the ISP and associates the IP address given by the ISP with the first network address in the filter.

### BACKGROUND OF THE INVENTION

1. Field of the Invention

The present invention relates generally to data communications, and in particular to network access and network interconnection.

2. Description of the Related Art

Historically, Internet service providers (ISPs) have used modem dial-up as the main way to access their services and the Internet. Other access methods such as via cable are also used, but the access methods are in many aspects similar. The ISPs use authentication procedures and protocols that rely on transport layer protocols. Examples of such protocols are Challenge-Handshake Authentication Protocol (CHAP), Password Authentication Protocol (PAP), and Point-to-Point Protocol Over Ethernet (PPPoE). These protocols originate in the client software on the user terminal and provide an end-to-end connection with the ISP. The security relies mainly on layer three (or lower) protocols, which has a high impact on the software on the terminal.

A problem with this solution is that an end-to-end protocol between the terminal and the ISP limits the user's mobility. In this case, mobility can be seen as the possibility to move around, or to use different terminals or different service providers.

A second problem is that there is a conflict between internal service provisioning, i.e. services in the network that provides initial access to the user, and external service offerings, such as for example services provided by an ISP.

The internal services, usually provided by the Local Area Network (LAN), comprise services such as for example local addressing, local Quality of Service (QoS), Virtual LANs (VLANs) authentication, and security. External services provided by e.g. ISPs comprise external IP-addressing, interconnectivity to the World Wide Web (WWW), Internet presence services and so on.

It can be appreciated that it would be advantageous to have solution for network access and interconnectivity that overcomes disadvantages of the prior art. This invention provides such a solution.

### SUMMARY OF THE INVENTION

In one aspect, the present invention is a method for providing a terminal in a first network with access to a second network. The terminal has a network address in the first network. A traffic node intercepts network traffic destined for the second network sent from the terminal. The traffic node verifies whether the terminal is authorised to send traffic of the kind that was intercepted, and, if this is not the case, notifies a network service node that the terminal has tried to send unauthorised traffic. The network service node directs the terminal to a forced portal and receives a log-on message comprising user information sent from the terminal. The network service node then verifies the user information in the logon message, and, if the user information is authenticated, informs the traffic node that the terminal is authorised to send the network traffic. The traffic node then establishes a connection with the second network and sends the network traffic to the second network.

In another aspect, the present invention is a system for providing a terminal in a first network with access to a second network. The terminal has a network address in the first network, and the system comprises a traffic node and a network service node. The traffic node intercepts network traffic destined for the second network sent from the terminal, verifies whether the terminal is authorised to send traffic of the kind that was intercepted. If the terminal is not authorised to send this kind of traffic, then the traffic node notifies a network service node that the terminal has tried to send unauthorised traffic. The network service node directs the terminal to a forced portal, receives a log-on message comprising user information sent from the terminal, verifies the user information in the log-on message, and, if the user information is authenticated, informs the traffic node that the terminal is authorised to send the network traffic. In response to a notification from the network service node that the terminal is authorised to send the network traffic, the traffic node further establishes a connection with the second network and sends the network traffic to the second network.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a block chart of a network environment;

FIG. 2 is a block chart illustrating an embodiment of a system according to the invention;

FIG. 3 is a flow chart of an embodiment of a method according to the invention; and

FIG. 4 is a signal flow chart for an embodiment of a method according to the invention.

### DETAILED DESCRIPTION OF THE PREFERRED EMBODIMENTS

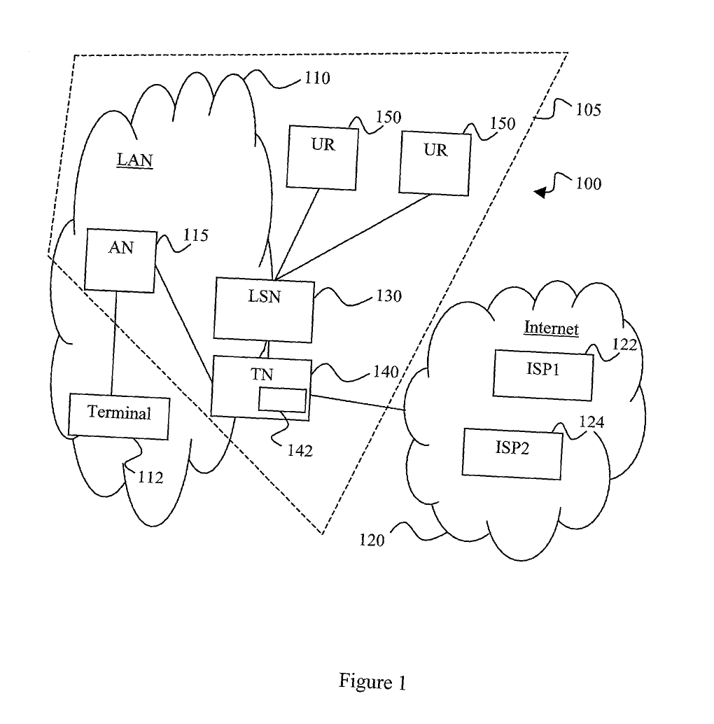

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale. Referring now to the figures, wherein FIG. 1 is a block chart of an exemplary network environment. The network environment 100 comprises a Local Area Network (LAN) 110 and the Internet 120 wherein a couple of Internet Service Providers (ISPs) reside, ISP1 122 and ISP2 124. The LAN 110 comprises an Access Node (AN) 115 that serves as the access point for the terminal 112. The AN 115 is further operably connected to a Traffic Node (TN) 140, which preferably is located on the border of the LAN 115. The TN 140 is further connected to the Internet 120 and a LAN Service Node (LSN) 130, of which the latter in turn is connected to a number of User Repositories (URs) 150.

The LSN 130 is a part of the LAN 110 and preferably handles tasks such as LAN IP address assignment, application layer authentication, presentation through a portal, event handling, policy control, and interfaces to one or more local or distributed UR 150.

The TN 140 handles transport functionality for layers up to and including the Transport layer, in order to filter on criteria for these levels, such as Media Access Control (MAC) address, IP address, and port number. The TN 140 also has a dynamic filter 142 that filters all the traffic arriving at it and only lets through the traffic that is allowed according to the current filter settings. The LSN 130 can change the filter settings.

The UR 150 may be located in the LAN 110 itself or elsewhere. For each user, it stores user information such as for example name, login name, password, and preferred ISP. In addition, the UR 150 may store information on user settings in one or more so called profiles (that may be parts of one big profile, in which case the user information may be part of the profile). One such profile may store general settings for the user, while other profiles may store information that depends on the terminal that is used or the user's context, e.g. settings to use when the user is at work and so on. The TN 140, the LSN 130, the URs 150, the LAN 110 and the AN 115 are components of a system 105 that may be referred to hereinafter.

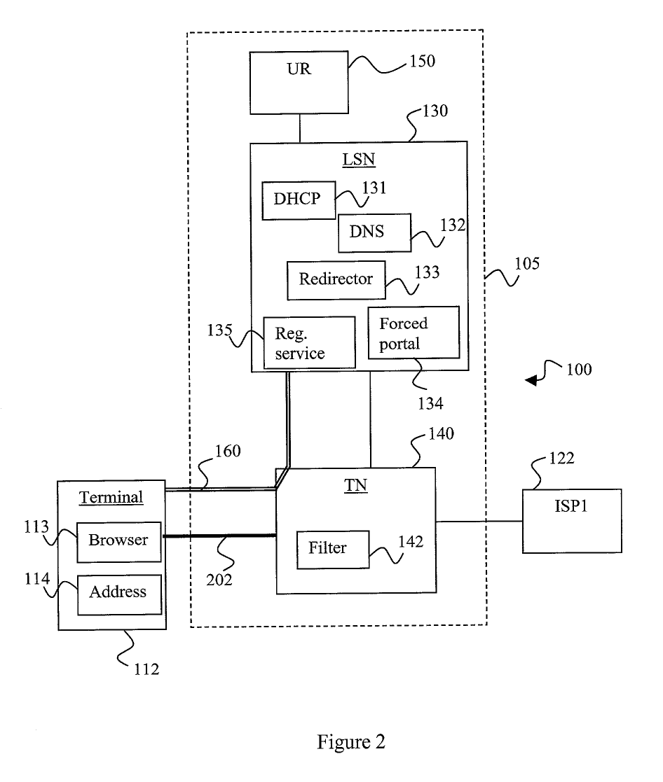

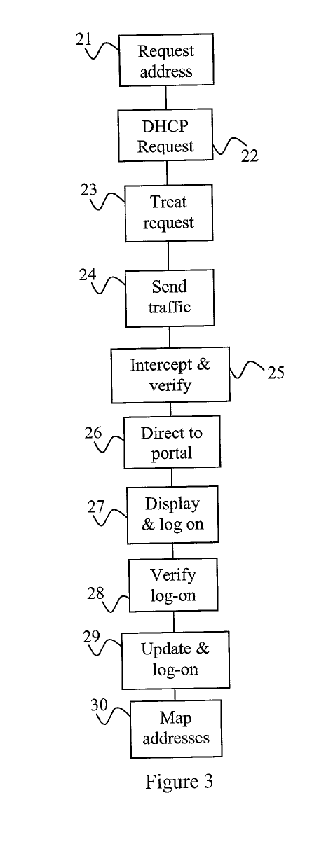

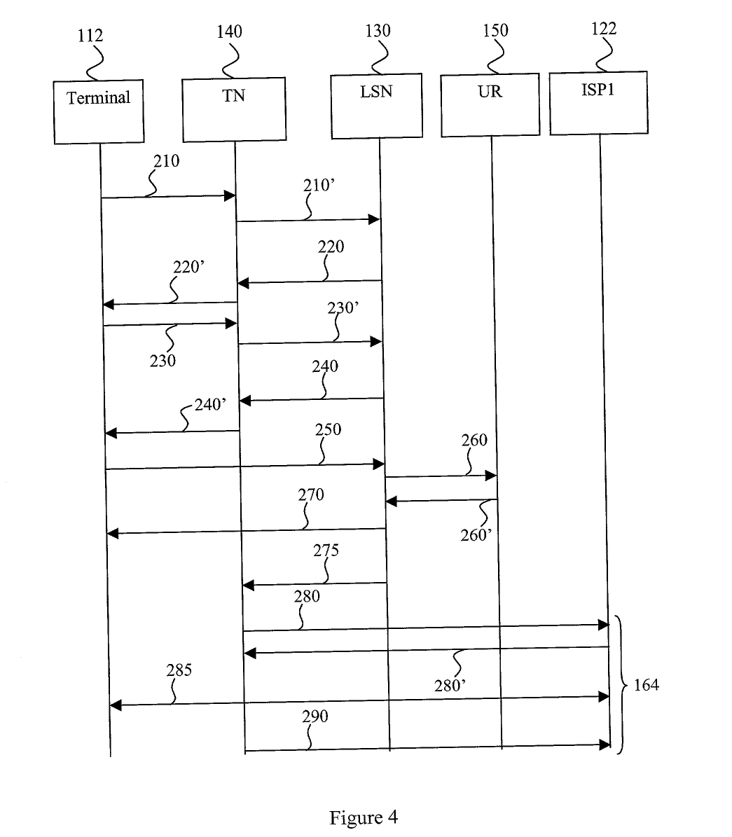

Reference is now made to FIGS. 2-4, wherein FIG. 2 shows a block chart of a system, FIG. 3 shows a flow chart of a method, and FIG. 4 shows a signal flow chart. The Figures only show the parts necessary for the understanding. The network environment 100 thus comprises ISP1 122, a terminal 112, and a system 105 that comprises the Traffic Node (TN) 140, the LAN Service Node (LSN) 130.

The TN 140 configures Virtual Networks on the LAN (110 in FIG. 1), such as the Virtual LAN (VLAN) 162 for the terminal 112. In a LAN 110 without Virtual Networks, users are able to send traffic all over the LAN 110, such as broadcasts that can be picked up by all other LAN users. With Virtual Networks, however, as is well known in the art, a number of virtual networks are created, such as for example one for each connected node. In the VLAN 202, a node can only send messages to other nodes within the VLAN 202—even though they are connected to the same LAN—including the controller of the VLAN 202, in this case the TN 140. Thus, the TN 140 controls the traffic on the LAN 110.

When the terminal 112 accesses the Local Access Network 110, it sends a request 210, such as a Dynamic Host Configuration Protocol (DHCP) request, for an IP address, step 21. The request 210 is broadcast over the LAN (not shown). The TN 140 picks up this request 210, recognizes that it is a DHCP request, and forwards it as message 210′ to a DHCP server 131, preferably located in the LSN 130, step 22.

Upon reception of the message 210′, the DHCP server 131 composes a message 220 comprising an IP address 114, the IP address of the default gateway, which is where the terminal 112 sends packets it cannot send directly, as it e.g. can do when the recipient is in the same LAN 110, and the default gateway then forwards the packets towards the intended recipient. The message 220 further comprises the IP address of the Domain Name Server (DNS) 132, preferably located in the LSN 130, and the subnet mask, and returns this message 220, step 23. The message 220 is sent to the TN 140 that forwards it to the terminal 112 as message 220′.

At this point, the terminal 112 has an IP address 114 and is able to send messages and other traffic over the LAN 110, and use those of the services provided by the LAN that are generally available.

When the user opens, i.e. activates, a web browser 113 on the terminal 112 and tries to access a web page, then Hypertext Transfer Protocol (HTTP) traffic is sent over the LAN to request the web page, such as a web page provided by ISP1 122, step 24. The HTTP traffic is sent as packages in at least one message 230 that is broadcast by the web browser 113.

At step 25, the TN 140 intercepts the at least one message 230. The TN 140 then validates the at least one message 230 against its filter 142 to verify whether the at least one message 230 is authorised. The TN 140, acting as a router, recognises that the HTTP request 230 satisfies a pre-set criteria, such as for example if it is the first HTTP request sent from the IP address since it was last allocated, the first request since the user logged out from the system 105 (but kept his LAN address) or the first request in a certain pre-set time. The fulfilled criteria indicate that the user should be given the possibility to log on to the system 105, and the TN 140 thus forwards the request 230 as request 230′ (that may be identical to the request 230) to a Redirector 133 in the LSN 130.

The Redirector 133 then directs the web browser 113 to a forced portal 134, step 26. This is done by sending the location (e.g. the URL) of the forced portal 134 to the web browser 113 in message 240, which is forwarded by the TN 140 as message 240′. The web browser 113 then requests the forced portal in message 244 and the forced portal 134 is returned in message 246. The forced portal 134 may for example comprise information about the services that are provided for free, and the conditions for the services that a charged for and that the user has to log on to use.

At step 27, the web browser 113 first displays the forced portal 134 and then handles log-on attempts by the user. The forced portal establishes a secure connection 160, such as a Hypertext Transfer Protocol Secure (HTTPS)/Secure Socket Layer (SSL) connection, with the LSN 130. It should be understood that the secure connection 160 could be said to use the normal connections with an extra layer of software security on top. The forced portal 134 may advantageously request a user to log on by providing for example user identification, a password and possibly the User Repository (UR) 150 where the user information is stored.

It is possible for this information to be stored by the terminal 112 so that it for example can respond autonomously to this request, with or without first asking the user. Thus it can be seen that the log-on requests the identification of the user in order to be able to provide services etc. as detailed in the UR 150. As part of the log-on, the system 105 may also advantageously request the terminal 112 to provide information about itself so that the system 105 may adapt services and presentation to the terminal's 112 capabilities. If the terminal 112 (or the user via the terminal 112) responds to the request to log on, then the given information is sent in a log-on message 250 over the secure connection 160 to the LSN 130, via the TN 140. The LSN 130 then verifies the information in the message 250 with the relevant information retrieved from the right UR 150, step 28, either earlier or now through request message 260 and response message 260′. At this point, at least three possibilities exist:

1. User and password information is correct.

2. Correct information is given.

3. The user identification is correct, but the password is wrong.

No Information is Correct:

If the user and password information provided in response to the request is incorrect, then the user may be considered unknown. In this case, then the user may, for example, either be refused access, or given the possibility to create a new account in the system 105. If the user chooses to create a new account, then he must provide user and billing information, and he may be given a choice of User Repository (UR) 150 for storage of this information. The system 105 then validates the information, and, if the validation is passed, the user is added to the system 105 according to the choices made, after which the user can access the system 105.

Correct Information is Given:

When the user is successfully authenticated by the system 105, the user may use the services provided by the LAN 110, if he has the proper access rights.

In addition, since the user has been authenticated, the method to access the requested web page continues. It will hereinafter be assumed that the LAN 110 cannot provide the web page.

The user Identification is Correct, But the Password is Wrong:

The terminal is not authenticated, but the user may be given one or more attempts to log on. If the correct information is given during one of these attempts, then the system 105 continues as under ‘correct information given’ hereinbefore. On the other hand, if the user does not successfully log on after the given number of attempts, then the system 105 continues as under no information is correct hereinbefore. 5

Usually, for each option hereinbefore, the system 105 sends a message 270, to inform the user of the result of the logon attempt.

Upon successful verification, the LSN 130 also sends a message 275 to inform the TN 140 that the user has been authenticated and that the traffic sent by the terminal 112 is allowed. The TN 140 then updates its filter 142 correspondingly and proceeds with the retrieval of the requested web page, step 29. The TN 140 initiates a connection session 164 with the corresponding ISP, e.g. ISP1 122. The user name and the password for the ISP are provided manually by the user, by the terminal 112 or by the TN 140 itself if the information can be collected from the UR 150—to the ISP's authentication server in message 280, i.e. the system logs the user on to ISP1 122. Upon successful authentication, the ISP returns an IP address in message 280′. This address is external to the LAN 110 and the TN 140 maps the external IP address to the internal address in the filter 142, step 30. This way, the TN 140 is able to translate between internal and external addresses and the terminal 112 can communicate with ISP1 122 in one or more messages 285 going between them.

The LSN 130 manages the user sessions in the system. This may for example comprise monitoring when a user logs out and setting expiration timers for sessions, so that the session expires if it is not used for a certain amount of time. Then, when the LSN 130 learns that a particular user is no longer using the system, it informs the relevant services of this and commands the resources (e.g. nodes and services) in the system 105 to release whatever resources corresponding to the user that they can release. For example, the connection session 164 to ISP1 122 is released and the entry for the terminal 112 in the filter 142 is deleted.

An example of a relevant service is a registered service, such as a presence service, i.e. the system 105 lets other users know that the user is logged on. Thus, when the user logs on, the LSN 130 informs its registered service 135, in this case the presence service, that the user is logged on. The service 135 will then be active until the LSN 130 determines that the user has logged out—e.g. by expressly logging out or by letting an inactivity timer expire—and informs the service 135 of this. Upon reception of this information, the service 135 takes appropriate action, such as for example removing the user from the list of users that are logged on to the system 105, and releases all resources corresponding to the user.

The TN 140 provides security in a number of ways, some of which have been discussed hereinbefore.

The forced portal 134 described hereinbefore enables unauthenticated traffic to be intercepted in the TN 140.

The forced portal 134 also uses HTTPS/SSL for secure information exchange.

In addition, the TN 140 configures VLANs to control the traffic on the LAN 110.

Furthermore, the TN 140 uses its filter 142 to prevent unauthorised access to restricted resources. The filter 142 also prevents spoofing. Using these security measures, there is no need for end-to-end tunnelling between the terminal 112 and the ISP, which means that mobility is increased.

It should be noted that it is possible for the filter 142 in the TN 140 to be configured to allow users access to e.g. the Internet without logging on or having to pay for it. This is entirely up to the owner of the system 105.

The system and method of the present invention have been described in particular reference to certain radio telecommunications messaging standards, it should be realized upon reference hereto that the innovative teachings contained herein are not necessarily limited thereto and may be implemented advantageously with any applicable radio telecommunications standard. It is believed that the operation and construction of the present invention will be apparent from the foregoing description. The method and system shown and described have are provided as exemplary embodiments of the invention, it will be readily apparent that various changes and modifications could be made therein without departing from the scope of the invention as defined by the claims set forth hereinafter.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for providing a terminal in a first network with access to a second network, the terminal having a network address in the first network, comprising the steps of:
intercepting by a traffic node network traffic sent from the terminal, wherein the network traffic is destined for the second network;
verifying by the traffic node whether the terminal is authorised to send traffic of the kind that was intercepted;
if the terminal is not authorised to send this kind of traffic:
notifying by the traffic node a network service node that the terminal has tried to send unauthorised traffic;
directing by the network service node the terminal to a forced portal;
receiving by the network service node a log-on message comprising user information sent from the terminal;
verifying by the network service node the user information in the log-on message;
if the user information is authenticated:
informing by the network service node the traffic node that the terminal is authorised to send the network traffic;
establishing by the traffic node a connection with the second network; and
sending by the traffic node the network traffic to the second network.

2. The method according to claim 1, further comprising the step of:
establishing by the traffic node a virtual network comprising the traffic node and the terminal.

3. The method according to claim 1, wherein the traffic node comprises a filter with information about authorised traffic, the method further comprising the step of:
updating, in response to reception of the information that the terminal is authorised to send the network traffic, by the traffic node the filter accordingly.

4. The method according to claim 1; wherein a secure connection is established between the forced portal and the network service node.

5. The method according to claim 1, the method further comprising, prior to the step of notifying by the traffic node a network service node that the terminal has tried to send unauthorised traffic the steps of:
determining by the traffic node whether a criteria for giving the user the possibility to log on is fulfilled; and
proceeding with the next step only if the criteria is fulfilled.

6. The method according to claim 1, further comprising the step of:
sending by the network service node to the terminal a message with the result of the verification.

7. The method according to claim 1, wherein the terminal has an active web browser, the network traffic is Hypertext Transfer Protocol (HTTP) traffic, and the second network belongs to an Internet Service Provider (ISP) with which the user has a subscription with corresponding user information, and wherein the step of establishing by the traffic node a connection with the second network further comprises the step of logging the user on to the ISP using the user information,
the method further comprising the steps of:
receiving by the traffic node a terminal network address for the second network; and
updating by the traffic node the filter with the network address for the second network, so that the traffic node can translate between the network addresses associated with the terminal in the two networks.

8. The method according to claim 1, wherein a user session is started upon successful verification, the method further comprising the step of:
managing by the network service node the user sessions by waiting for a user to log-out or for an inactivity timer for a user session to expire; and
in response to a user log-out or an inactivity timer expiration, ordering by the network service node the release of resources associated with the corresponding user.

9. A system for providing a terminal in a first network with access to a second network, the terminal having a network address in the first network, the system comprising:
a traffic node that:
intercepts network traffic destined for the second network sent from the terminal;
verifies whether the terminal is authorised to send traffic of the kind that was intercepted;
if the terminal is not authorised to send this kind of traffic:
notifies a network service node that the terminal has tried to send unauthorised traffic; and
in response to a notification from the network service node that the terminal is authorised to send the network traffic:
establishes a connection with the second network; and
sends the network traffic to the second network; and
a network service node that:
directs the terminal to a forced portal;
receives a log-on message comprising user information sent from
the terminal;
verifies the user information in the log-on message; and
if the user information is authenticated:
informs the traffic node that the terminal is authorised to send the network traffic.

10. The system according to claim 8, wherein the traffic node further establishes a virtual network comprising the traffic node and the terminal.

11. The system according to claim 8, wherein the traffic node comprises a filter with information about authorised traffic, and the traffic node further, in response to reception of the information that the terminal is authorised to send the network traffic, updates the filter accordingly.

12. The system according to claim 8, further comprising a secure connection between the forced portal and the network service node.

13. The system according to claim 8, wherein the traffic node determines whether a criteria for giving the user the possibility to log on is fulfilled, and notifies the network service node only if the criteria for giving the user the possibility to log on is fulfilled.

14. The system according to claim 8, wherein the network service node further sends a message with the result of the verification to the terminal.

15. The system according to claim 8, wherein the terminal has an active web browser, the network traffic is Hypertext Transfer Protocol (HTTP) traffic, and the second network belongs to an Internet Service Provider (ISP) with which the user has a subscription with corresponding user information, and wherein the traffic node establishes a connection with the second network by logging the user on to the ISP using the user information, and wherein the traffic node further receives a terminal network address for the second network and updates the filter with the network address for the second network, so that the traffic node can translate between the network addresses associated with the terminal in the two networks.

16. The system according to claim 8, wherein a user session is started upon successful verification, and wherein the network service node further:
manages the user sessions by waiting for a user to log-out or for an inactivity timer for a user session to expire; and
in response to a user log-out or an inactivity timer expiration, orders the release of resources associated with the corresponding user.
